(19) United States
(12) Patent Application Publication
(10) Pub. No.: US 2018/0176650 A1
(43) Pub. Date: Jun. 21, 2018

(54) INFORMATION PROCESSING APPARATUS AND INFORMATION PROCESSING METHOD

(71) Applicant: SONY CORPORATION, TOKYO (JP)

(72) Inventors: MITSUHIRO HIRABAYASHI, TOKYO (JP); YOICHI YAGASAKI, TOKYO (JP); NOBUAKI IZUMI, KANAGAWA (JP); MITSURU KATSUMATA, TOKYO (JP)

(21) Appl. No.: 15/578,709

(22) PCT Filed: May 30, 2016
(86) PCT No.: PCT/JP2016/065866

§ 371 Date: Nov. 30, 2017

(30) Foreign Application Priority Data
Jun. 12, 2015 (JP) 2015-119361

(51) Int. Cl. H04N 21/472; H04N 21/4728; H04N 5/232; H04N 21/434; H04N 21/2343; H04N 21/4402; H04L 29/06

(52) U.S. Cl. CPC H04N 21/47205; H04N 21/4728; H04N 5/23238; H04L 65/607; H04N 21/23439; H04N 21/44029; H04N 21/47202; H04N 21/4347

(57) ABSTRACT

The present disclosure relates to an information processing apparatus and an information processing method which are capable of recognizing the continuity of ends of an image. A file generating apparatus sets continuity information representing the continuity of ends of an entire celestial sphere image compatible with encoded streams. The present disclosure is applicable to a file generating apparatus, etc. of an information processing system that distributes encoded streams of an entire celestial sphere image as an image of a moving-image content to a moving-image playback terminal according to a process equivalent to MPEG-DASH (Moving Picture Experts Group phase-Dynamic Adaptive Streaming over HTTP), for example.

### TECHNICAL FIELD

The present disclosure relates to an information processing apparatus and an information processing method, and more particularly to an information processing apparatus and an information processing method which are capable of recognizing the continuity of ends of an image.

### BACKGROUND ART

In recent years, OTT-V (Over The Top Video) has become mainstream in the streaming services on the Internet. One technique that has started to come into wide use as the fundamental technology for OTT-V is MPEG-DASH (Moving Picture Experts Group phase-Dynamic Adaptive Streaming over HTTP (HyperText Transfer Protocol)) (see, for example, NPL 1).

According to MPEG-DASH, a distribution server provides encoded streams having different bit rates for one moving-image content, and a playback terminal demands encoded streams having an optimum bit rate, thereby realizing adaptive streaming distribution.

MPEG-DASH SRD (Spatial Relationship Description) extension defines SRD indicating the position on a screen of one or more individually encoded regions into which an image of a moving-image content has been divided (see, for example, NPLs 2 and 3). The SRD makes it possible to realize a ROI (Region of Interest) function of spatial adaptation for selectively acquiring an encoded stream of an image of a desired regions, using a bitrate adaptation method for selectively acquiring encoded streams having desired bit rates.

Images of moving-image contents include not only images captured through angles of field by a single camera, but also entire celestial sphere images where images captured horizontally around 360° or vertically around 180° are mapped onto 2D (Two-Dimensional) images (planar images), and panoramic images captured horizontally around 360°.

Since entire celestial sphere images and panoramic images are images where ends are contiguous, if encoded streams of some ends of these images are decoded, then highly possible regions to be decoded next are other ends contiguous to those ends.

### CITATION LIST

### Patent Literature

### [NPL 1]

MPEG-DASH (Dynamic Adaptive Streaming over HTTP) (URL: http://mpeg.chiariglione.org/standards/mpeg-dash/media-presentation-description-and-segment-formats/text-isoiec-23009-12012-dam-1)

### [NPL 2]

“Text of ISO/IEC 23009-1:2014 FDAM 2 Spatial Relationship Description, Generalized URL parameters and other extensions,” N15217, MPEG111, Geneva, February 2015

### [NPL 3]

“WD of ISO/IEC 23009-3 2nd edition AMD 1 DASH Implementation Guidelines,” N14629, MPEG109, Sapporo, July 2014

### SUMMARY

### Technical Problem

However, decoding devices are unable to recognize the continuity of ends of entire celestial sphere images and panoramic images compatible with encoded streams. Therefore, while decoding the encoded stream of a certain end, the decoding devices are unable to shorten a decoding time by reading ahead the encoded stream of another end contiguous to that end.

The present disclosure has been made under the circumstances described above, and is aimed at recognizing the continuity of ends of an image.

### Solution to Problem

An information processing apparatus according to a first aspect of the present disclosure is an information processing apparatus including a setting section that sets continuity information representing continuity of ends of an image compatible with encoded streams.

An information processing method according to the first aspect of the present disclosure corresponds to the information processing apparatus according to the first aspect of the present disclosure.

According to the first aspect of the present disclosure, continuity information representing the continuity of ends of an image compatible with encoded streams is set.

An information processing apparatus according to a second aspect of the present disclosure is an information processing apparatus including an acquirer that acquires encoded streams on the basis of continuity information representing continuity of ends of an image compatible with the encoded streams, and a decoder that decodes the encoded streams acquired by the acquirer.

An information processing method according to the second aspect of the present disclosure corresponds to the information processing apparatus according to the second aspect of the present disclosure.

According to the second aspect of the present disclosure, encoded streams are acquired on the basis of continuity information representing the continuity of ends of an image compatible with the encoded streams, and the acquired encoded streams are decoded.

The information processing apparatus according to the first and second aspects can be implemented by a computer when it executes programs.

In order to implement the information processing apparatus according to the first and second aspects, the programs to be executed by the computer can be provided by being transmitted through a transmission medium or recorded on a recording medium.

### Advantageous Effects of Invention

According to the first aspect of the present disclosure, information can be set. According to the first aspect of the present disclosure, information can be set in a manner to be able to recognize the continuity of ends of an image.

According to the second aspect of the present disclosure, information can be acquired. According to the second aspect of the present disclosure, the continuity of ends of an image can be recognized.

The advantages described above are not necessarily restrictive in nature, but any of the advantages described in the present disclosure are applicable.

### BRIEF DESCRIPTION OF DRAWINGS

FIG. 1 is a block diagram depicting a configurational example of a first embodiment of an information processing system to which the present disclosure is applied.

FIG. 2 is a block diagram depicting a configurational example of an image file generator of a file generating apparatus depicted in FIG. 1.

FIG. 3 is a diagram illustrative of an encoded stream of an entire celestial sphere image.

FIG. 4 is a diagram illustrative of an example of definition of an SRD in the first embodiment.

FIG. 5 is a diagram illustrative of another example of definition of an SRD in the first embodiment.

FIG. 6 is a diagram depicting an SRD of an end image described in an MPD (Media Presentation Description) file.

FIG. 7 is a diagram illustrative of an example of definition of an SRD.

FIG. 8 is a diagram illustrative of an example of an MPD file in the first embodiment.

FIG. 9 is a diagram depicting another example of continuity information described in the MPD file.

FIG. 10 is a flowchart of an encoding process of the image file generator depicted in FIG. 2.

FIG. 11 is a block diagram depicting a configurational example of a streaming player implemented by a moving-image playback terminal depicted in FIG. 1.

FIG. 12 is a flowchart of a playback process of the streaming player depicted in FIG. 11.

FIG. 13 is a diagram depicting an example of the segment structure of an image file of an end image in a second embodiment of the information processing system to which the present disclosure is applied.

FIG. 14 is a diagram depicting an example of Tile Region Group Entry in FIG. 13.

FIG. 15 is a diagram depicting an example of an MPD file in the second embodiment.

FIG. 16 is a diagram depicting an example of a track structure.

FIG. 17 is a diagram depicting another example of an leva box in the second embodiment.

FIG. 18 is a diagram depicting another example of an MPD file in the second embodiment.

FIG. 19 is a diagram depicting an example of an image to be encoded in a third embodiment of the information processing system to which the present disclosure is applied.

FIG. 20 is a diagram depicting an example of continuity information described in the MPD file.

FIG. 21 is a diagram depicting an example of region information of filler images depicted in FIG. 19.

FIG. 22 is a block diagram depicting a configurational example of the hardware of a computer.

### DESCRIPTION OF EMBODIMENTS

Modes (hereinafter referred to as “embodiments”) for carrying out the present disclosure will be described below. The description will be given in the following order.

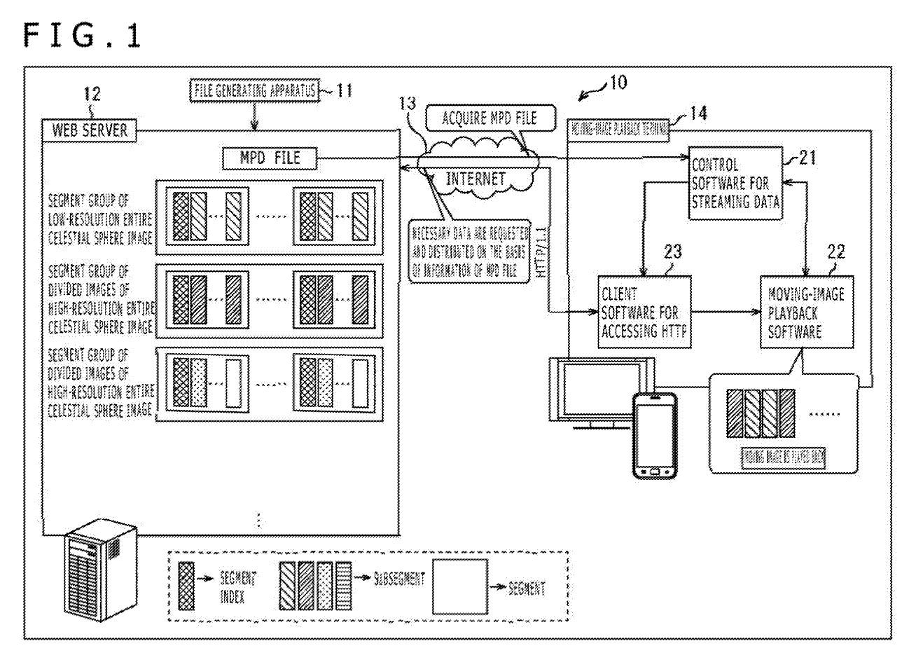

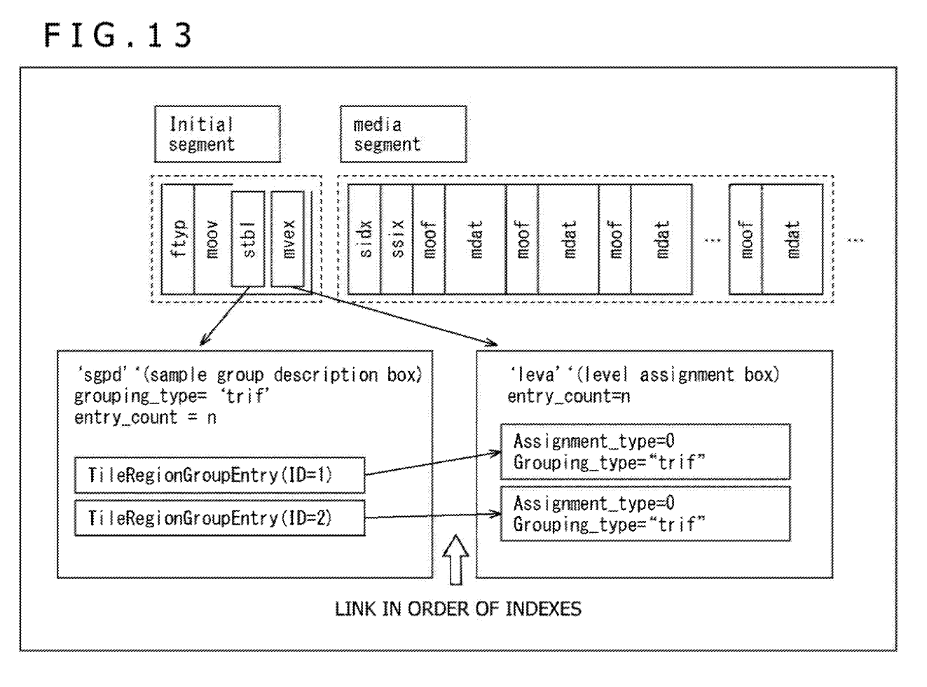

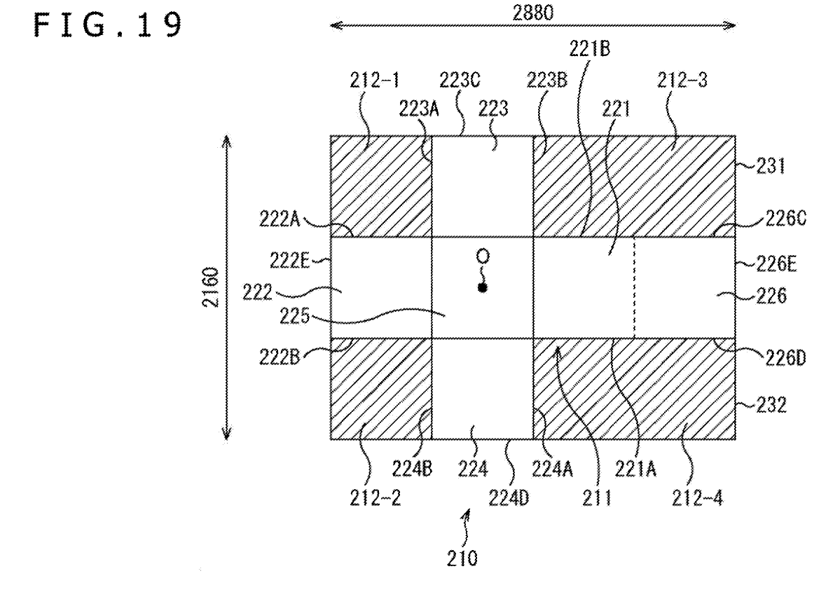

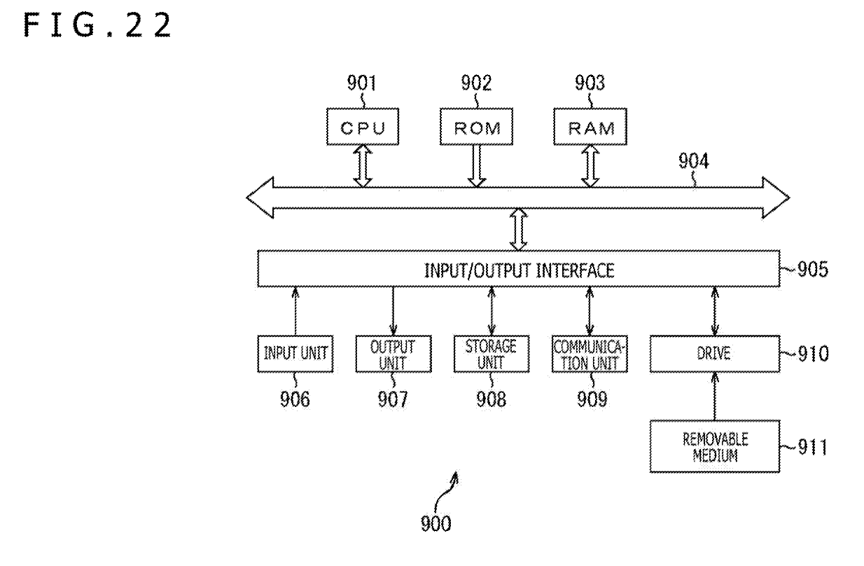

1. First embodiment: Information processing system (FIGS. 1 through 12)
2. Second embodiment: Information processing system (FIGS. 13 through 18)
3. Third embodiment: Information processing system (FIGS. 19 through 21)
4. Fourth embodiment: Computer (FIG. 22)

### First Embodiment

### (Configurational Example of a First Embodiment of an Information Processing System)

FIG. 1 is a block diagram depicting a configurational example of a first embodiment of an information processing system to which the present disclosure is applied.

An information processing system 10 depicted in FIG. 1 includes a Web server 12 connected to a file generating apparatus 11, and a moving-image playback terminal 14, the Web server 12 and the moving-image playback terminal 14 being connected to each other over the Internet 13.

In the information processing system 10, the Web server 12 distributes encoded streams of an entire celestial sphere image as an image of a moving-image content to the moving-image playback terminal 14 according to a process equivalent to MPEG-DASH.

In the present specification, the entire celestial sphere image refers to an image according to equidistant cylindrical projection for spheres, where an image captured horizontally around 360° or vertically around 180° (hereinafter referred to as “omnidirectional image”) is mapped onto a spherical plane. However, the entire celestial sphere image may be an image representing a development of a cube, where an omnidirectional image is mapped onto the cube.

The file generating apparatus 11 of the information processing system 10 encodes a low-resolution entire celestial sphere image to generate a low-resolution encoded stream. The file generating apparatus 11 also independently encodes images divided from a high-resolution entire celestial sphere image to generate high-resolution encoded streams of the respective divided images. The file generating apparatus 11 generates image files by converting the low-resolution encoded stream and the high-resolution encoded streams into files each per time unit called “segment” ranging from several to ten seconds. The file generating apparatus 11 uploads the generated image files to the Web server 12.

The file generating apparatus 11 (setting section) is an information processing apparatus that generates an MPD file (management file) for managing image files, etc. The file generating apparatus 11 uploads the MPD file to the Web server 12.

The Web server 12 stores the image files and the MPD file uploaded from the file generating apparatus 11. In response to a request from the moving-image playback terminal 14, the Web server 12 sends the image files, the MPD file, etc. that have been stored therein to the moving-image playback terminal 14.

The moving-image playback terminal 14 executes software 21 for controlling streaming data (hereinafter referred to as “control software”), moving-image playback software 22, and client software 23 for accessing HTTP (HyperText Transfer Protocol) (hereinafter referred to as “access software”), etc.

The control software 21 is software for controlling data streaming from the Web server 12. Specifically, the control software 21 enables the moving-image playback terminal 14 to acquire the MPD file from the Web server 12.

Based on the MPD file, the control software 21 instructs the access software 23 to send a request for sending encoded streams to be played which are designated by the moving-image playback software 22.

The moving-image playback software 22 is software for playing the encoded streams acquired from the Web server 12. Specifically, the moving-image playback software 22 indicates encoded streams to be played to the control software 21. Furthermore, when the moving-image playback software 22 receives a notification of having started receiving streams from the access software 23, the moving-image playback software 22 decodes the encoded streams received by the moving-image playback terminal 14 into image data. The moving-image playback software 22 combines the decoded image data and outputs the combined image data.

The access software 23 is software for controlling communication with the Web server 12 over the Internet 13 using HTTP. Specifically, in response to the instruction from the control software 21, the access software 23 controls the moving-image playback terminal 14 to send a request for sending encoded streams to be played that are included in image files. The access software 23 also controls the moving-image playback terminal 14 to start receiving the encoded streams that are sent from the Web server 12 in response to the request, and supplies a notification of having started receiving streams to the moving-image playback software 22.

### (Configurational Example of an Image File Generator)

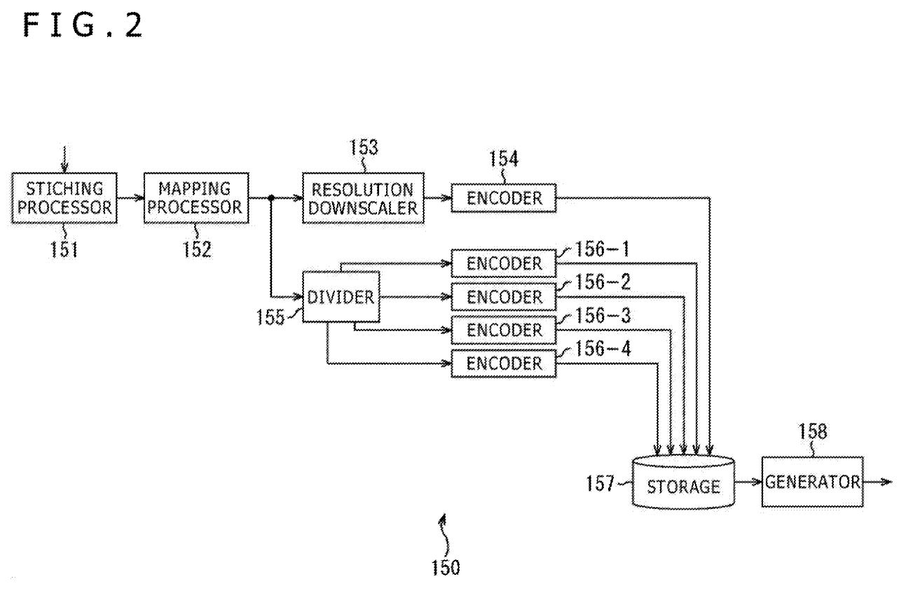

FIG. 2 is a block diagram depicting a configurational example of an image file generator for generating image files, of the file generating apparatus 11 depicted in FIG. 1.

As depicted in FIG. 2, an image file generator 150 includes a stitching processor 151, a mapping processor 152, a resolution downscaler 153, an encoder 154, a divider 155, encoders 156-1 through 156-4, a storage 157, and a generator 158.

The stitching processor 151 equalizes the colors and lightnesses of omnidirectional images supplied from multi-cameras, not depicted, and join them while removing overlaps. The stitching processor 151 supplies an omnidirectional image obtained as a result to the mapping processor 152.

The mapping processor 152 (generator) maps the omnidirectional image supplied from the stitching processor 151 onto a sphere, thereby generating an entire celestial sphere image. The mapping processor 152 supplies the entire celestial sphere image to the resolution downscaler 153 and the divider 155. The stitching processor 151 and the mapping processor 152 may be integrated with each other.

The resolution downscaler 153 reduces the horizontal and vertical resolutions of the entire celestial sphere image supplied from the mapping processor 152 to one-half, thereby downscaling the resolution of the image and generating a low-resolution entire celestial sphere image. The resolution downscaler 153 supplies the low-resolution entire celestial sphere image to the encoder 154.

The encoder 154 encodes the low-resolution entire celestial sphere image supplied from the resolution downscaler 153 according to an encoding process such as AVC (Advanced Video Coding), HEV (High Efficiency Video Coding), or the like, thereby generating a low-resolution encoded stream. The encoder 154 supplies the low-resolution encoded stream to the storage 157, which records the supplied low-resolution encoded stream therein.

The divider 155 divides the entire celestial sphere image supplied as a high-resolution entire celestial sphere image from the mapping processor 152 vertically into three regions, and divides the central region horizontally into three regions such that no boundary lies at the center. The divider 155 downscales the resolution of the upper and lower regions among the five divided regions such that the horizontal resolution is reduced to one-half, for example.

The divider 155 supplies a low-resolution upper image, which represents the upper region whose resolution has been downscaled, to the encoder 156-1, and supplies a low-resolution lower image, which represents the lower region whose resolution has been downscaled, to the encoder 156-2.

The divider 155 combines the left end of the left end region of the central region with the right end of the right end region thereof, thereby generating an end image. The divider 155 supplies the end image to the encoder 156-3. The divider 155 also supplies the central one of the central region as a central image to the encoder 156-4.

The encoders 156-1 through 156-4 (encoders) encode the low-resolution upper image, the low-resolution lower image, the end image, and the central image supplied from the divider 155, according to an encoding process such as AVC, HEVC, or the like. The encoders 156-1 through 156-4 supply encoded streams thus generated as high-resolution streams to the storage 157, which records the supplied high-resolution streams therein.

The storage 157 records therein the single low-resolution encoded stream supplied from the encoder 154 and the four high-resolution encoded streams supplied from the encoders 156-1 through 156-4.

The generator 158 reads the single low-resolution encoded stream and the four high-resolution encoded streams from the storage 157, and converts each of them into files each per segment. The generator 158 transmits the image files thus generated to the Web server 12 depicted in FIG. 1.

### (Description of an Encoded Stream of an Entire Celestial Sphere Image)

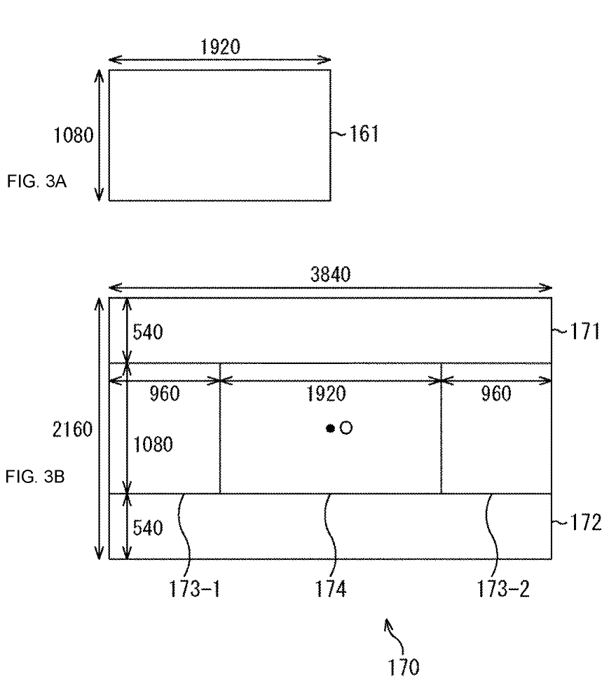

FIG. 3 is a diagram illustrative of an encoded stream of an entire celestial sphere image.

If the resolution of an entire celestial sphere image 170 is 4 k (3840 pixels×2160 pixels), as depicted in FIG. 3, then the horizontal resolution of a low-resolution entire celestial sphere image 161 is 1920 pixels that is one-half of the horizontal resolution of the entire celestial sphere image 170, and the vertical resolution of the low-resolution entire celestial sphere image 161 is 1080 pixels that is one-half of the vertical resolution of the entire celestial sphere image 170, as depicted in FIG. 3 at A. The low-resolution entire celestial sphere image 161 is encoded as it is, generating a single low-resolution encoded stream.

As depicted in FIG. 3 at B, the entire celestial sphere image 170 is divided vertically into three regions, and the central region thereof is divided horizontally into three regions such that no boundary lies at the center O. As a result, the entire celestial sphere image 170 is divided into an upper image 171 as the upper region of 3840 pixels×540 pixels, a lower image 172 as the lower region of 3840 pixels×540 pixels, and the central region of 3840 pixels×1080 pixels. The central region of 3840 pixels×1080 pixels is divided into a left end image 173-1 as the left region of 960 pixels×1080 pixels, a right end image 173-2 as the right region of 960 pixels×1080 pixels, and a central image 174 as the central region of 1920 pixels×1080 pixels.

The upper image 171 and the lower image 172 have their horizontal resolution reduced to one-half, generating a low-resolution upper image and a low-resolution lower image. Since the entire celestial sphere image is an image that spreads horizontally and vertically through 360 degrees, the left end image 173-1 and the right end image 173-2 that face each other are actually continuous images. The left end of the left end image 173-1 is combined with the right end of the right end image 173-2, generating an end image. The low-resolution upper image, the low-resolution lower image, the end image, and the central image 174 are encoded independently of each other, generating four high-resolution encoded streams.

Generally, the entire celestial sphere image 170 is generated such that the front of the entire celestial sphere image 170 at a position on the entire celestial sphere image 170 that is located at the center of the field of view in the standard direction of sight lies at the center O of the entire celestial sphere image 170.

According to an encoding process such as AVC, HEVC, or the like where information is compressed by temporal motion compensation, when a subject moves on a screen, the appearance of a compression distortion is propagated between frames while being kept in a certain shape. However, if a screen is divided and the divided images are encoded independently of each other, then since motion compensation is not carried out across boundaries, a compression distortion tends to increase. As a result, a moving image made up of decoded divided images has a stripe generated therein where the appearance of a compression distortion varies at the boundaries between the divided images. This phenomenon is known to occur between slices of AVC or tiles of HEVC. Therefore, image quality is likely to deteriorate at the boundaries between the low-resolution upper image, the low-resolution lower image, the end image, and the central image 174 that have been decoded.

Consequently, the entire celestial sphere image 170 is divided such that no boundary lies at the center O of the entire celestial sphere image 170 which it is highly possible for the user to see. As a result, image quality does not deteriorate at the center O which it is highly possible for the user to see, making any image quality deterioration unobtrusive in the entire celestial sphere image 170 that has been decoded.

The left end image 173-1 and the right end image 173-2 are combined with each other and encoded. Therefore, if the areas of the end images and the central image 174 are the same, then a maximum of high-resolution encoded streams of an entire celestial sphere image from a given viewpoint which are required to display the entire celestial sphere image are two high-resolution encoded streams of either one of the low-resolution upper image and the low-resolution lower image and either one of the end image and the central image 174, independently of the viewpoint. Therefore, the number of high-resolution streams to be decoded by the moving-image playback terminal 14 is the same independently of the viewpoint.

### (Description of the Definition of an SRD in the First Embodiment)

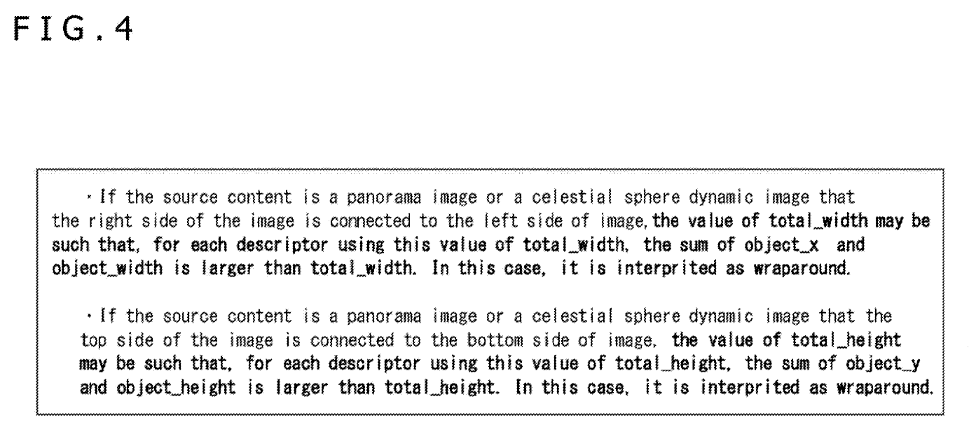

FIG. 4 is a diagram illustrative of an example of definition of an SRD in the first embodiment.

An SRD refers to information that can be described in an MPD file, and represents information indicating the position on a screen of one or more individually encoded regions into which an image of a moving-image content has been divided.

Specifically, an SRD is given as <SupplementalProperty schemeldUri=“urn:mpeg:dash:srd:2015” value=“source_id, object_x, object_y, object_width, object_height, total_width, total_height, spatial_set_id”/>.

“source_id” refers to the ID (identifier) of a moving-image content corresponding to the SRD. “object_x” and “object_y” refer respectively to the horizontal and vertical coordinates on a screen of an upper left corner of a region corresponding to the SRD. “object_width” and “object_height” refer respectively to the horizontal and vertical sizes of the region corresponding to the SRD. “total_width” and “total_height” refer respectively to the horizontal and vertical sizes of a screen where the region corresponding to the SRD is placed. “spatial_set_id” refers to the ID of the screen where the region corresponding to the SRD is placed.

As depicted in FIG. 4, according to the definition of SRD in the present embodiment, if an image of a moving-image content is a panoramic image (panorama image) or an entire celestial sphere image (celestial sphere dynamic), then the sum of “object_x” and “object_width” may exceed “total_width,” and the sum of “object_y” and “object_height” may exceed “total_height.”

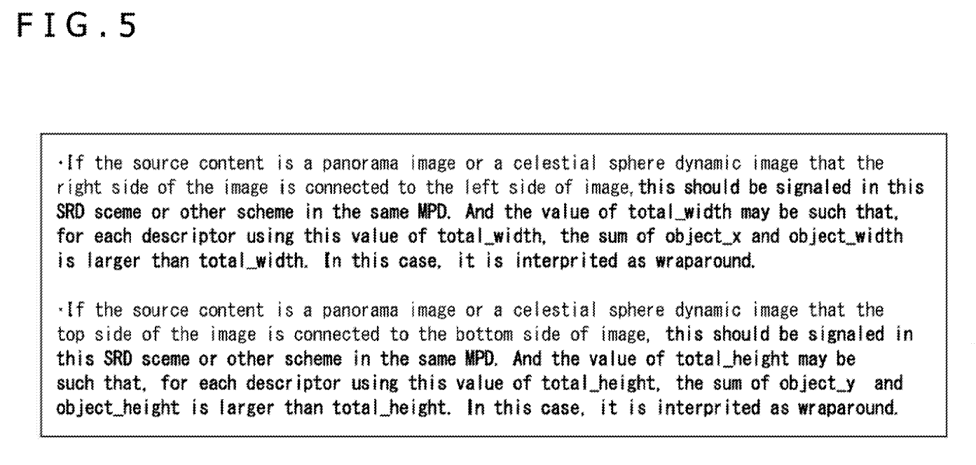

Information indicating that an image of a moving-image content is a panoramic image (panorama image) or an entire celestial sphere image (celestial sphere dynamic) may be described in an MPD file. In this case, the definition of SRD in the present embodiment is depicted in FIG. 5.

### (Description of an SRD of an End Image)

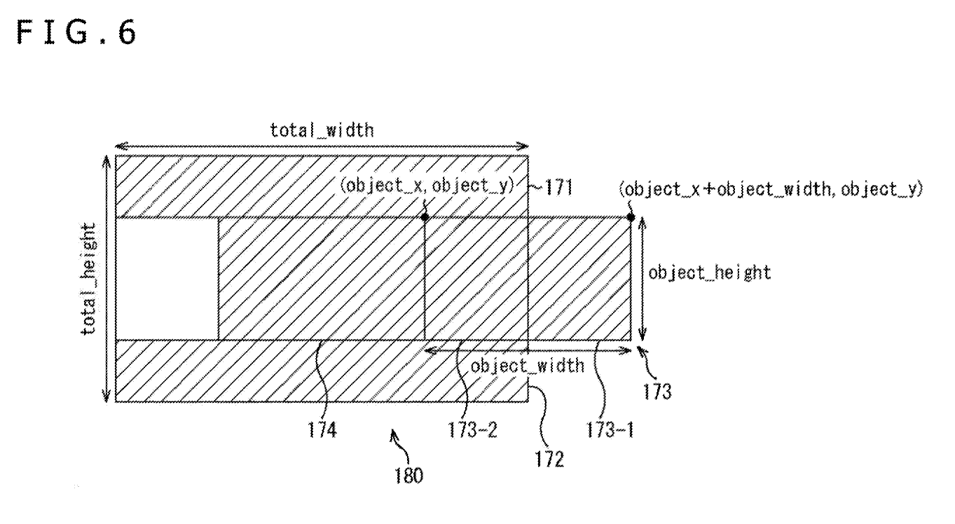

FIG. 6 is a diagram depicting an SRD of an end image described in an MPD file.

As described above with reference to FIG. 4, according to the SRD in the first embodiment, if an image of a moving-image content is an entire celestial sphere image, then the sum of “object_x” and “object_width” may exceed “total_width.”

Therefore, the file generating apparatus 11 sets the position of the left end image 173-1 on a screen 180 to the right side of the right end image 173-2, for example. As depicted in FIG. 6, the position of the left end image 173-1 on the screen 180 now protrudes out of the screen 180. However, the positions on the screen 180 of the right end image 173-2 and the left end image 173-1 that make up the end image 173 are rendered contiguous. Consequently, the file generating apparatus 11 can describe the position of the end image 173 on the screen 180 with an SRD.

Specifically, the file generating apparatus 11 describes the horizontal and vertical coordinates of the position on the screen 180 of an upper left corner of the right end image 173-2 as “object_x” and “object_y” of the SRD of the end image 173, respectively. The file generating apparatus 11 also describes the horizontal and vertical sizes of the end image 173 as “object_width” and “object_height” of the SRD of the end image 173, respectively.

The file generating apparatus 11 also describes the horizontal and vertical sizes of the screen 180 as “total_width” and “total_height” of the SRD of the end image 173, respectively. The file generating apparatus 11 thus sets the position protruding out of the screen 180 as the position of the end image 173 on the screen 180.

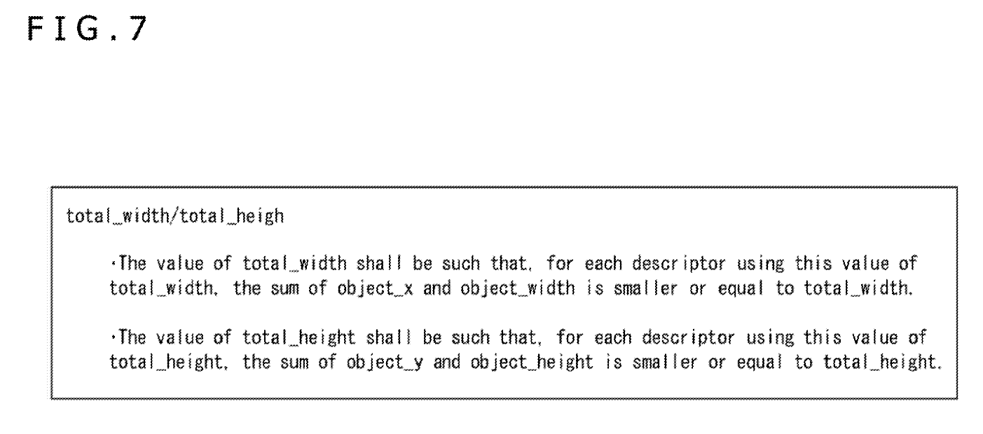

By contrast, if the definition of an SRD is limited such that the sum of “object_x” and “object_width” is equal to or smaller than “total_width” and the sum of “object_y” and “object_height” is equal to or smaller than “total_height,” as depicted in FIG. 7, i.e., if the position on the screen of the region corresponding to the SRD is inhibited from protruding out of the screen, then the position of the left end image 173-1 on the screen 180 cannot be set to the right side of the right end image 173-2.

Therefore, the positions on the screen 180 of the right end image 173-2 and the left end image 173-1 that make up the end image 173 are not contiguous, and the positions on the screen 180 of both the right end image 173-2 and the left end image 173-1 need to be described as the position of the end image 173 on the screen 180. As a consequence, the position of the end image 173 on the screen 180 cannot be described by an SRD.

### (Example of an MPD File)

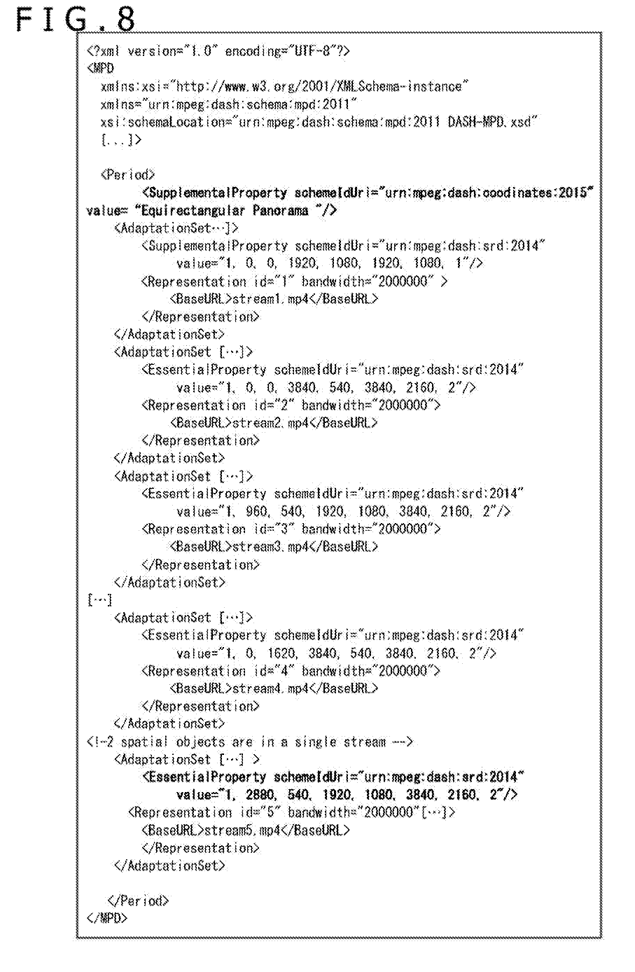

FIG. 8 is a diagram illustrative of an example of an MPD file generated by the file generating apparatus 11 depicted in FIG. 1.

As depicted in FIG. 8, in the MPD file, “Period” corresponding to a moving-image content is described. “Period” has information representing a mapping process for an entire celestial sphere image, described therein as continuity information representing the continuity of ends of the entire celestial sphere image as an image of the moving-image content.

Mapping processes include an equirectangular projection process and a cube mapping process. The equirectangular projection process refers to a process for mapping an omnidirectional image onto a spherical plane and using an equirectangular projection image of the mapped sphere as an entire celestial sphere image. The cube mapping process refers to a process for mapping an omnidirectional image onto a cubic plane and using a development of the mapping cube as an entire celestial sphere image.

According to the first embodiment, the mapping process for the entire celestial sphere image is the equirectangular projection process. Therefore, “Period” has <SupplementalProperty schemeldUri=“urn:mpeg:dash:coodinates:2015” value=“Equirectangular Panorama”/> which indicates that the mapping process is the equirectangular projection process, described therein as continuity information.

In “Period,” “AdaptationSet” is also described per encoded stream. Each “AdaptationSet” has the SRD of the corresponding region described therein and “Representation” described therein. “Representation” has information, such as the URL (Uniform Resource Locator) of the image file of the corresponding encoded stream, described therein.

Specifically, the first “AdaptationSet” in FIG. 8 is the “AdaptationSet” of a low-resolution encoded stream of the low-resolution entire celestial sphere image 161 of the entire celestial sphere image 170. Therefore, the first “AdaptationSet” has <SupplementalProperty schemeldUri=“urn:mpeg:dash:srd:2014” value=“1,0,0,1920,1080,1920,1080,1”/> that represents the SRD of the low-resolution entire celestial sphere image 161 described therein. The “Representation” of the first “AdaptationSet” has the URL “stream1.mp4” of the image file of the low-resolution encoded stream described therein.

The second “AdaptationSet” in FIG. 8 is the “AdaptationSet” of a high-resolution encoded stream of the low-resolution upper image of the entire celestial sphere image 170. Therefore, the second “AdaptationSet” has <SupplementalProperty schemeldUri=“urn:mpeg:dash:srd:2014” value=“1,0,0,3840,540,3840,2160,2”/> that represents the SRD of the low-resolution upper image described therein. The “Representation” of the second “AdaptationSet” has the URL “stream2.mp4” of the image file of the high-resolution encoded stream of the low-resolution upper image described therein.

The third “AdaptationSet” in FIG. 8 is the “AdaptationSet” of a high-resolution encoded stream of the central image 174 of the entire celestial sphere image 170. Therefore, the third “AdaptationSet” has <SupplementalProperty schemeldUri=“urn:mpeg:dash:srd:2014” value=“1,960,540,1920,1080,3840,2160,2”/> that represents the SRD of the central image 174 described therein. The “Representation” of the third “AdaptationSet” has the URL “stream3.mp4” of the image file of the high-resolution encoded stream of the central image 174 described therein.

The fourth “AdaptationSet” in FIG. 8 is the “AdaptationSet” of a high-resolution encoded stream of the low-resolution lower image of the entire celestial sphere image 170. Therefore, the fourth “AdaptationSet” has <SupplementalProperty schemeldUri=“urn:mpeg:dash:srd:2014” value=“1,0,1620,3840,540,3840,2160,2”/> that represents the SRD of the low-resolution lower image described therein. The “Representation” of the fourth “AdaptationSet” has the URL “stream4.mp4” of the image file of the high-resolution encoded stream of the low-resolution lower image described therein.

The fifth “AdaptationSet” in FIG. 8 is the “AdaptationSet” of a high-resolution encoded stream of the end image 173 of the entire celestial sphere image 170. Therefore, the fifth “AdaptationSet” has <SupplementalProperty schemeldUri=“urn:mpeg:dash:srd:2014” value=“1,2880,540,1920,1080,3840,2160,2”/> that represents the SRD of the end image 173, described therein. The “Representation” of the fifth “AdaptationSet” has the URL “stream5.mp4” of the image file of the high-resolution encoded stream of the end image 173 described therein.

In the example depicted in FIG. 8, the continuity information is described in “Period.” However, the continuity information may be described in “AdaptationSet.” If the continuity information is described in “AdaptationSet,” then it may be described in all occurrences of “AdaptationSet” described in “Period,” or may be described in either one representative occurrence of “AdaptationSet.”

### (Another Example of Continuity Information)

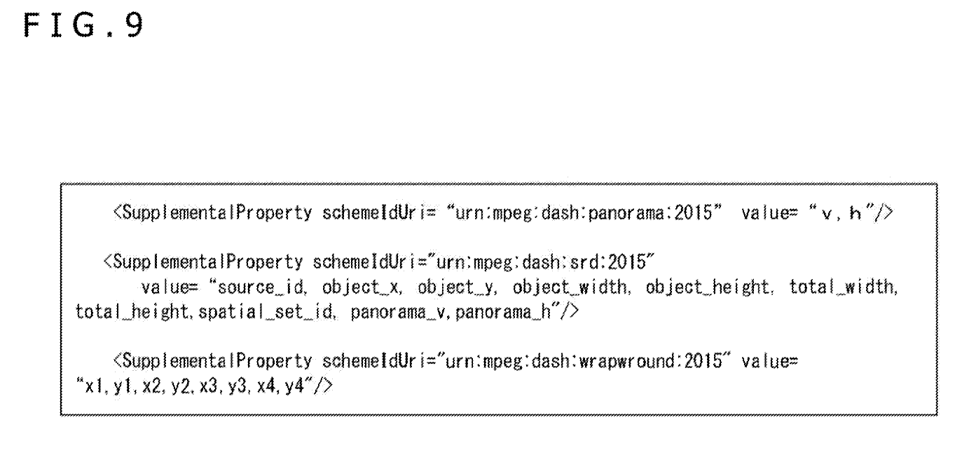

FIG. 9 is a diagram depicting another example of continuity information described in the MPD file.

As depicted in FIG. 9, continuity information may be information indicating whether the continuity of ends in horizontal and vertical directions of an entire celestial sphere image is present or absent, for example. In this case, <SupplementalProperty schemeldUri=“urn:mpeg:dash:panorama:2015” value=“v,h”/> is described as the continuity information.

“v” is 1 if the continuity of horizontal ends is present, i.e., the left and right ends of the entire celestial sphere image are contiguous, and is 0 if the continuity of horizontal ends is absent, i.e., the left and right ends of the entire celestial sphere image are not contiguous. Since the entire celestial sphere image 170 is an image where the horizontal ends are contiguous, “v” is set to 1 in the first embodiment.

“h” is 1 if the continuity of vertical ends is present, i.e., the upper and lower ends of the entire celestial sphere image are contiguous, and is 0 if the continuity of vertical ends is absent, i.e., the upper and lower ends of the entire celestial sphere image are not contiguous. Since the entire celestial sphere image 170 is an image where the vertical ends are not contiguous, “h” is set to 0 in the first embodiment.

The continuity information may be described by being included in the SRD by expanding the definition of the SRD. In this case, as depicted in FIG. 9, the SRD is given as <SupplementalProperty schemeldUri=“urn:mpeg:dash:srd:2015” value=“source_id, object_x, object_y, object_width, object_height, total_width, total_height, spatial_set_id, panorama_v,panorama_h”/>. “panorama_v,” “panorama_h” correspond respectively to “v,” “h” referred to above.

The continuity information may be information indicating sides as contiguous ends of the entire celestial sphere image. In this case, <SupplementalProperty schemeldUri=“urn:mpeg:dash:wrapwround:2015” value=“x1,y1,x2,y2,x3,y3,x4,y4”/> is described as the continuity information.

“x1,” “y1,” “x2,” “y2” represent the x and y coordinates of respective starting and ending points of one of the two contiguous sides of the entire celestial sphere image, and “x3,” “y3,” “x4,” “y4” represent the x and y coordinates of respective starting and ending points of the other of the two contiguous sides of the entire celestial sphere image.

For example, if the entire celestial sphere image of 3840 pixels×2160 pixels is placed as it is on the screen, then its left side having a starting point (0,0) and an ending point (0, 2160) and its right side having a starting point (3840,0) and an ending point (3840,2160) are contiguous to each other. Therefore, “x1,y1,x2,y2,x3,y3,x4,y4” is written as “0,0,2160,3840,0,3840,2160.”

### (Description of a Process of the Image File Generator)

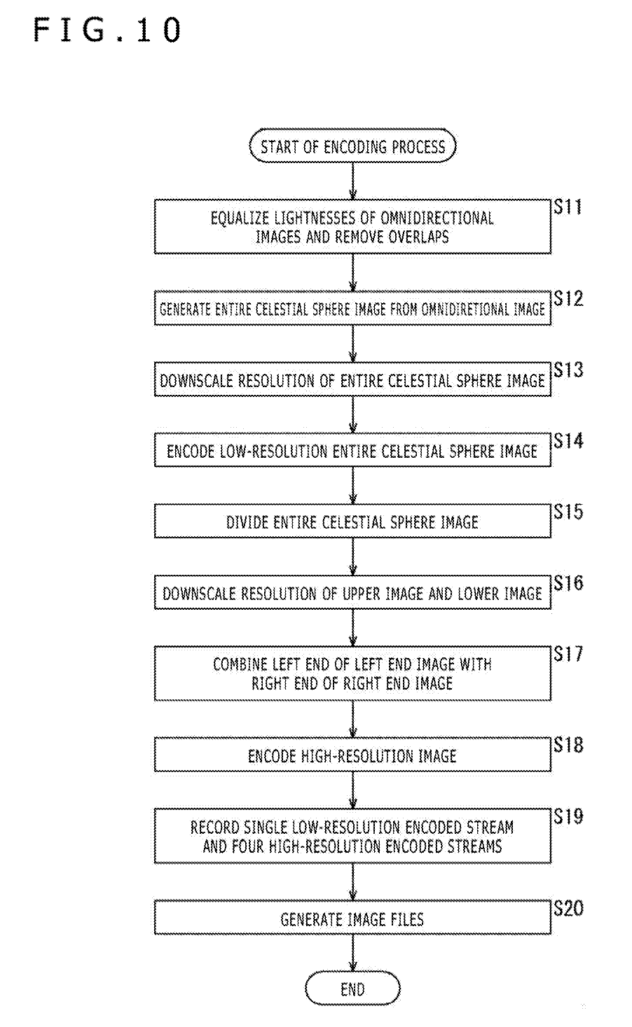

FIG. 10 is a flowchart of an encoding process of the image file generator 150 depicted in FIG. 2.

In step S11 depicted in FIG. 10, the stitching processor 151 equalizes the colors and lightnesses of omnidirectional images supplied from the multi-cameras, not depicted, and join them while removing overlaps. The stitching processor 151 supplies an omnidirectional image obtained as a result to the mapping processor 152.

In step S12, the mapping processor 152 generates an entire celestial sphere image 170 from the omnidirectional image supplied from the stitching processor 151, and supplies the entire celestial sphere image 170 to the resolution downscaler 153 and the divider 155.

In step S13, the resolution downscaler 153 downscales the resolution of the entire celestial sphere image 170 supplied from the mapping processor 152, generating a low-resolution entire celestial sphere image 161. The resolution downscaler 153 supplies the low-resolution entire celestial sphere image 161 to the encoder 154.

In step S14, the encoder 154 encodes the low-resolution entire celestial sphere image 161 supplied from the resolution downscaler 153, thereby generating a low-resolution encoded stream. The encoder 154 supplies the low-resolution encoded stream to the storage 157.

In step S15, the divider 155 divides the entire celestial sphere image 170 supplied from the mapping processor 152 into an upper image 171, a lower image 172, a left end image 173-1, a right end image 173-2, and a central image 174. The divider 155 supplies the central image 174 to the encoder 156-4.

In step S16, the divider 155 downscales the resolution of the upper image 171 and the lower image 172 such that their horizontal resolution is reduced to one-half. The divider 155 supplies a low-resolution upper image obtained as a result to the encoder 156-1 and also supplies a low-resolution lower image, which represents the lower region whose resolution has been downscaled, to the encoder 156-2.

In step S17, the divider 155 combines the left end of the left end image 173-1 with the right end of the right end image 173-2, thereby generating an end image 173. The divider 155 supplies the end image 173 to the encoder 156-3.

In step S18, the encoders 156-1 through 156-4 encode the low-resolution upper image, the low resolution lower image, the end image 173, and the central image 174, respectively, supplied from the divider 155. The encoders 156-1 through 156-4 supply encoded streams generated as a result as high-resolution streams to the storage 157.

In step S19, the storage 157 records therein the single low-resolution encoded stream supplied from the encoder 154 and the four high-resolution encoded streams supplied from the encoders 156-1 through 156-4.

In step S20, the generator 158 reads the single low-resolution encoded stream and the four high-resolution encoded streams from the storage 157, and converts each of them into files each per segment, thereby generating image files. The generator 158 transmits the image files to the Web server 12 depicted in FIG. 1. The encoding process is now ended.

### (Functional Configurational Example of a Moving-Image Playback Terminal)

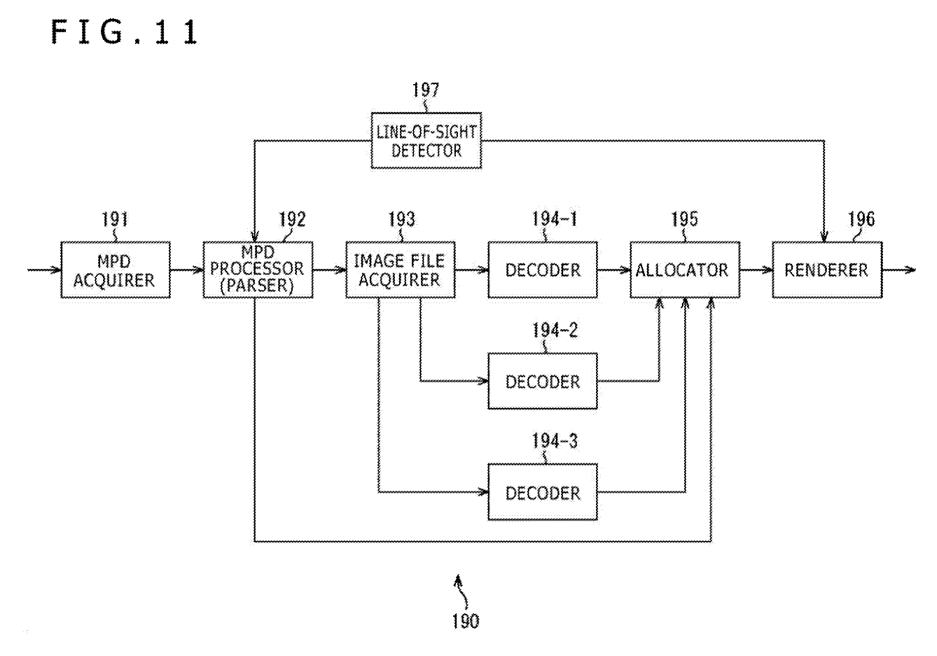

FIG. 11 is a block diagram depicting a configurational example of a streaming player that is implemented by the moving-image playback terminal 14 depicted in FIG. 8 when it executes the control software 21, the moving-image playback software 22, and the access software 23.

The streaming player 190 depicted in FIG. 11 includes an MPD acquirer 191, an MPD processor 192, an image file acquirer 193, decoders 194-1 through 194-3, an allocator 195, a renderer 196, and a line-of-sight detector 197.

The MPD acquirer 191 of the streaming player 190 acquires an MPD file from the Web server 12, and supplies the MPD file to the MPD processor 192.

Based on the direction of sight of the user supplied from the line-of-sight detector 197, the MPD processor 192 selects two of the upper image 171, the lower image 172, the end image 173, and the central image 174 as selected images that may possibly be included in the field of view of the user. Specifically, when the entire celestial sphere image 170 is mapped onto a spherical plane, the MPD processor 192 selects one of the upper image 171 and the lower image 172 and one of the end image 173 and the central image 174 which may be possibly included in the field of view of the user when the user that exists within the sphere looks along the direction of sight, as selected images.

When the selected images are changed, the MPD processor 192 extracts information such as URLs of the image files of the low-resolution entire celestial sphere image 161 and the selected images in the segments to be played, from the MPD file supplied from the MPD acquirer 191, and supplies the extracted information to the image file acquirer 193. The MPD processor 192 also extracts the SRDs of the low-resolution entire celestial sphere image 161 and the selected images in the segments to be played, from the MPD file, and supplies the extracted SRDs to the allocator 195.

After having extracted the information of the URLs, etc. of the image files of the selected image, the MPD processor 192 selects the upper image 171, the lower image 172, the end image 173, or the central image 174 that has an end contiguous to the end of the selected image, as an intended selected image, on the basis of the continuity information in the MPD file. The MPD processor 192 extracts information of the URLs, etc. of the image files of the intended selected image in the segments to be played from the MPD file, and supplies the extracted information to the image file acquirer 193. The MPD processor 192 also extracts the SRD of the intended selected image in the segments to be played from the MPD file, and supplies the extracted SRD to the allocator 195.

The image file acquirer 193 requests the Web server 12 for the low-resolution encoded streams of the image files of the low-resolution entire celestial sphere image 161 that are specified by the URLs supplied from the MPD processor 192, and acquires the encoded streams. The image file acquirer 193 supplies the acquired low-resolution encoded stream to the decoder 194-1.

If the selected image is not the previous intended selected image, then the image file acquirer 193 requests the Web server 12 for the encoded streams of the image files of the selected image that are specified by the URLs supplied from the MPD processor 192, and acquires the encoded streams. The image file acquirer 193 supplies the high-resolution encoded stream of one of the selected images to the decoder 194-2, and supplies the high-resolution encoded stream of the other selected image to the decoder 194-3.

Further, after the selected images are acquired, the image file acquirer 193 (acquirer) requests the Web server 12 for the high-resolution encoded streams of the image files of the intended selected images that are specified by the URLs supplied from the MPD processor 192, and acquires the high-resolution encoded streams. The image file acquirer 193 supplies the high-resolution encoded stream of one of the intended selected images to the decoder 194-2, and supplies the high-resolution encoded stream of the other intended selected image to the decoder 194-3.

The decoder 194-1 decodes the low-resolution encoded stream supplied from the image file acquirer 193 according to a process corresponding to an encoding process such as AVC, HEVC, or the like, and supplies the low-resolution entire celestial sphere image 161 obtained as a result of the decoding process to the allocator 195.

The decoders 194-2 and 194-3 (decoders) decode the high-resolution encoded streams of the selected images supplied from the image file acquirer 193 according to a process corresponding to an encoding process such as AVC, HEVC, or the like. The decoders 194-2 and 194-3 then supply the selected images obtained as a result of the decoding process to the allocator 195.

The allocator 195 places the low-resolution entire celestial sphere image 161 supplied from the decoder 194-1 on the screen on the basis of the SRD supplied from the MPD processor 192. Thereafter, the allocator 195 superposes the selected images supplied from the decoders 194-2 and 194-3 on the screen where the low-resolution entire celestial sphere image 161 has been placed, on the basis of the SRD.

Specifically, the horizontal and vertical sizes of the screen where the low-resolution entire celestial sphere image 161 indicated by the SRD is placed are one-half of the horizontal and vertical sizes of the screen where the selected images are placed. Therefore, the allocator 195 increases twice the horizontal and vertical sizes of the screen where the low-resolution entire celestial sphere image 161 is placed, and superposes the selected images thereon. The allocator 195 maps the screen on which the selected images have been superposed onto a sphere, and supplies a spherical image obtained as a result to the renderer 196.

The renderer 196 projects the spherical image supplied from the allocator 195 onto the field of view of the user supplied from the line-of-sight detector 197, thereby generating an image in the field of view of the user. The renderer 196 then controls a display device, not depicted, to display the generated image as a display image.

The line-of-sight detector 197 detects the direction of sight of the user. The direction of sight of the user may be detected by a detecting method based on the gradient of a device worn by the user, for example. The line-of-sight detector 197 supplies the detected direction of sight of the user to the MPD processor 192.

The line-of-sight detector 197 also detects the position of the user. The position of the user may be detected by a detecting method based on a captured image of a marker or the like that is added to a device worn by the user, for example. The line-of-sight detector 197 determines a field of view of the user based on the detected position of the user and the line-of-sight vector, and supplies the determined field of view of the user to the renderer 196.

### (Description of a Process of the Moving-Image Playback Terminal)

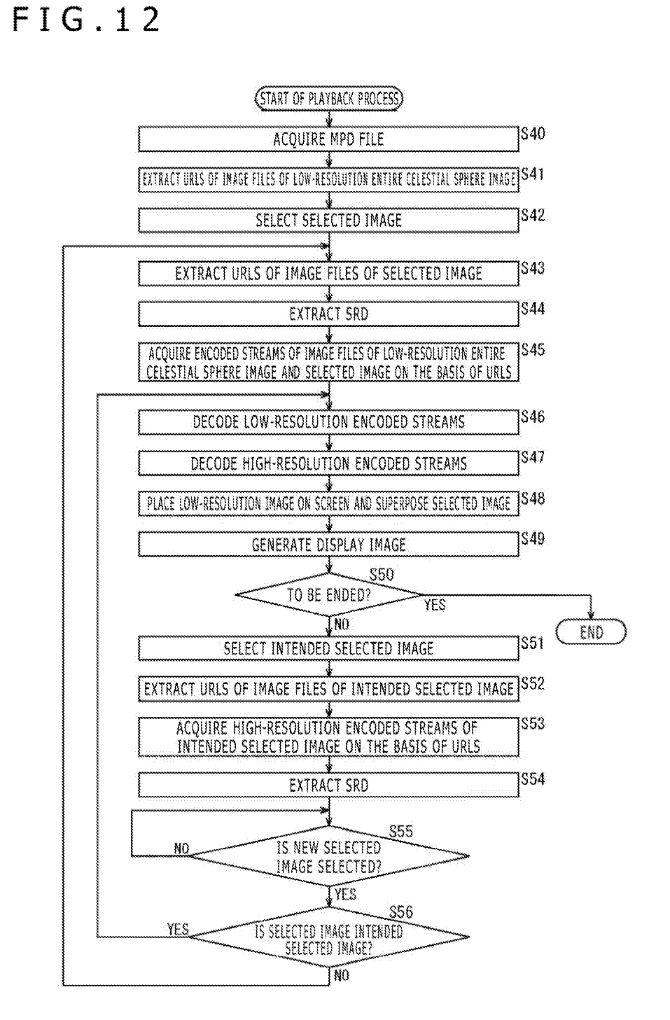

FIG. 12 is a flowchart of a playback process of the streaming player 190 depicted in FIG. 11.

In step S40 depicted in FIG. 12, the MPD acquirer 191 of the streaming player 190 acquires the MPD file from the Web server 12 and supplies the acquired MPD file to the MPD processor 192.

In step S41, the MPD processor 192 extracts information such as URL of the image file of the low-resolution entire celestial sphere image 161 in the segments to be played, from the MPD file supplied from the MPD acquirer 191, and supplies the extracted information to the image file acquirer 193.

In step S42, the MPD processor 192 selects two of the upper image 171, the lower image 172, the end image 173, and the central image 174 as selected images that may possibly be included in the field of view of the user, on the basis of the direction of sight of the user supplied from the line-of-sight detector 197.

In step S43, the MPD processor 192 extracts information such as URLs of the image files of the selected images in the segments to be played, from the MPD file supplied from the MPD acquirer 191, and supplies the extracted information to the image file acquirer 193.

In step S44, the MPD processor 192 extracts the SRDs of the selected images in the segments to be played, from the MPD file, and supplies the extracted SRDs to the allocator 195.

In step S45, the image file acquirer 193 requests the Web server 12 for the encoded streams of the image files of the low-resolution entire celestial sphere image 161 and the selected images that are specified by the URLs supplied from the MPD processor 192, and acquires the encoded streams. The image file acquirer 193 supplies the acquired low-resolution encoded stream to the decoder 194-1. The image file acquirer 193 also supplies the high-resolution encoded stream of one of the selected images to the decoder 194-2, and supplies the high-resolution encoded stream of the other selected image to the decoder 194-3.

In step S46, the decoder 194-1 decodes the low-resolution encoded stream supplied from the image file acquirer 193, and supplies the low-resolution entire celestial sphere image 161 obtained as a result of the decoding process to the allocator 195.

In step S47, the decoders 194-2 and 194-3 decode the high-resolution encoded streams of the selected images supplied from the image file acquirer 193, and supplies the selected images obtained as a result of the decoding process to the allocator 195.

In step S48, the allocator 195 places the low-resolution entire celestial sphere image 161 supplied from the decoder 194-1 on the screen on the basis of the SRD supplied from the MPD processor 192. Thereafter, the allocator 195 superposes the selected images supplied from the decoders 194-2 and 194-3 on the screen. The allocator 195 maps the screen on which the selected images have been superposed onto a sphere, and supplies a spherical image obtained as a result to the renderer 196.

In step S49, the renderer 196 projects the spherical image supplied from the allocator 195 onto the field of view of the user supplied from the line-of-sight detector 197, thereby generating an image to be displayed. The renderer 196 then controls the display device, not depicted, to display the generated image as a display image.

In step S50, the streaming player 190 determines whether the playback process is to be ended or not. If the streaming player 190 decides that the playback process is not to be ended in step S50, then control goes to step S51.

In step S51, the MPD processor 192 selects the upper image 171, the lower image 172, the end image 173, or the central image 174 which is contiguous to the end of the selected image, as an intended selected image, on the basis of the continuity information in the MPD file.

In step S52, the MPD processor 192 extracts information of the URLs, etc. of the image files of the intended selected image in the segments to be played from the MPD file, and supplies the extracted information to the image file acquirer 193.

In step S53, the image file acquirer 193 requests the Web server 12 for the high-resolution encoded streams of the image files of the intended selected image that are specified by the URLs supplied from the MPD processor 192, and acquires the encoded streams.

In step S54, the MPD processor 192 extracts the SRD of the intended selected image in the segments to be played from the MPD file, and supplies the extracted SRD to the allocator 195.

In step S55, the MPD processor 192 selects a selected image based on the direction of line-of-sight of the user supplied from the line-of-sight detector 197, and determines whether a new selected image is selected or not. In other words, the MPD processor 192 determines whether a selected image that is different from the previously selected image is selected or not.

If the MPD processor 192 decides that a new selected image is not selected in step S55, then it waits until a new selected image is selected. If the MPD processor 192 decides that a new selected image is selected in step S55, then control goes to step S56.

In step S56, the image file acquirer 193 determines whether the new selected image is the intended selected image. If the image file acquirer 193 decides that the new selected image is the intended selected image in step S56, then control goes back to step S46, repeating the subsequent process.

If the image file acquirer 193 decides that the new selected image is not the intended selected image in step S56, then control goes back to step S43, repeating the subsequent process.

As described above, continuity information is set in the MPD file. Therefore, the streaming player 190 is able to read ahead an intended selected image that has an end contiguous to the end of the selected image, which is highly possible to be decoded next to the selected image, on the basis of the continuity information, when a selected image is to be selected. As a result, when the intended selected image is selected as a selected image, it is not necessary to read the selected image when it is to be decoded, resulting in a reduction in the decoding time.

### Second Embodiment

### (Example of the Segment Structure of the Image File of an End Image)

According to a second embodiment of the image processing system to which the present disclosure is applied, different levels (to be described in detail later) are set for the encoded stream of the left end image 173-1 and the encoded stream of the right end image 173-2, among the encoded streams of the end image 173. As a consequence, if an SRD is defined as depicted in FIG. 7, then the positions of the left end image 173-1 and the right end image 173-2 on the screen 180 can be described using the SRD.

Specifically, the second embodiment of the image processing system to which the present disclosure is applied is the same as the first embodiment except the segment structure of the image file of the end image 173 generated by the file generating apparatus 11 and the MPD file. Therefore, only the segment structure of the image file of the end image 173 and the MPD file will be described below.

FIG. 13 is a diagram depicting an example of the segment structure of the image file of the end image 173 in the second embodiment of the information processing system to which the present disclosure is applied.

As depicted in FIG. 13, in the image file of the end image 173, an Initial segment includes an ftyp box and an moov box. The moov box includes an stbl box and an mvex box placed therein.

The stbl box includes an sgpd box, etc. placed therein where Tile Region Group Entry indicating the position of the left end image 173-1 as part of the end image 173 on the end image 173 and Tile Region Group Entry indicating the position of the right end image 173-2 on the end image 173 are successively described. Tile Region Group Entry is standardized by HEVC Tile Track of HEVC File Format.

The mvex box includes an leva box, etc. placed therein where 1 is set as the level for the left end image 173-1 corresponding to the first Tile Region Group Entry and 2 is set as the level for the right end image 173-2 corresponding to the second Tile Region Group Entry.

The leva box sets 1 as the level for the left end image 173-1 and 2 as the level for the right end image 173-2 by successively describing information of the level corresponding to the first Tile Region Group Entry and information of the level corresponding to the second Tile Region Group Entry. The level functions as an index when part of an encoded stream is designated from an MPD file.

The leva box has assignment_type described therein that indicates whether the object for which a level is to be set is an encoded stream placed on a plurality of tracks or not as information of each level. In the example depicted in FIG. 13, the encoded stream of the end image 173 is placed on one track. Therefore, the assignment_type is set to 0 indicating that the object for which a level is to be set is not an encoded stream placed on a plurality of tracks.

The leva box also has the type of Tile Region Group Entry corresponding to the level described therein as information of each level. In the example depicted in FIG. 13, “trif” representing the type of Tile Region Group Entry described in the sgpd box is described as information of each level. Details of the leva box are described in ISO/IEC 14496-12 ISO base media file format 4th edition, July 2012, for example.

A media segment includes one or more subsegments including an sidx box, an ssix box, and pairs of moof and mdat boxes. The sidx box has positional information placed therein which indicates the position of each subsegment in the image file. The ssix box includes positional information of the encoded streams of respective levels placed in the mdat boxes.

A subsegment is provided per desired time length. The mdat boxes have encoded streams placed together therein for a desired time length, and the moof boxes have management information of those encoded streams placed therein.

### (Example of Tile Region Group Entry)

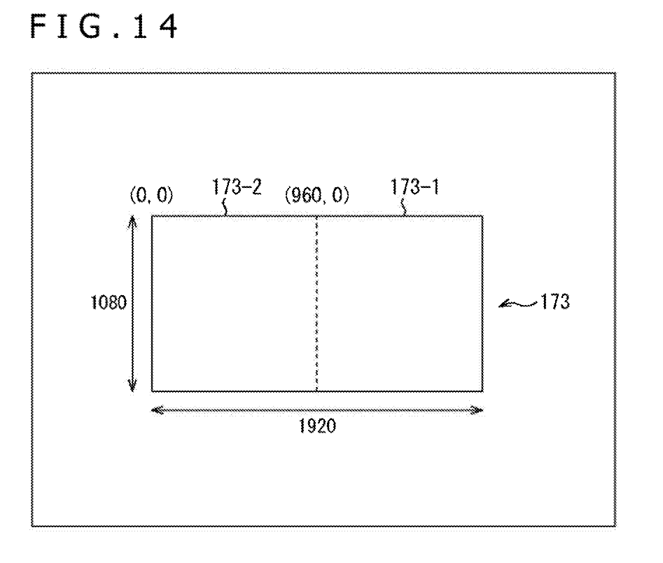

FIG. 14 is a diagram depicting an example of Tile Region Group Entry in FIG. 13.

Tile Region Group Entry describes successively therein the ID of the Tile Region Group Entry, horizontal and vertical coordinates of an upper left corner of the corresponding region on an image corresponding to the encoded stream, and horizontal and vertical sizes of the image corresponding to the encoded stream.

As depicted in FIG. 14, the end image 173 is made up of the right end image 173-2 of 960 pixels×1080 pixels and the left end image 173-1 of 960 pixels×1080 pixels whose left end is combined with the right end of the right end image 173-2. Therefore, the Tile Region Group Entry of the left end image 173-1 is represented by (1,960,0,960,1080), and the Tile Region Group Entry of the right end image 173-2 is represented by (2,0,0,960,1080).

### (Example of an MPD File)

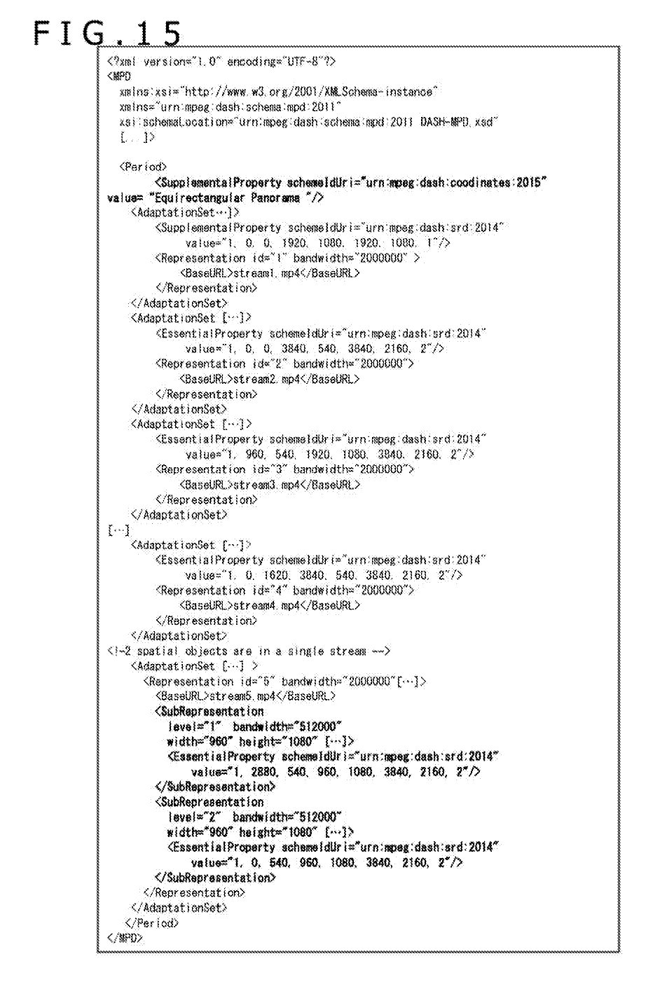

FIG. 15 is a diagram depicting an example of an MPD file.

The MPD file depicted in FIG. 15 is the same as the MPD file depicted in FIG. 8 except for the fifth “AdaptationSet” which is the “AdaptationSet” of the high-resolution encoded stream of the end image 173. Therefore, only the fifth “AdaptationSet” will be described below.

The fifth “AdaptationSet” depicted in FIG. 15 does not have the SRD of the end image 173 described therein, but has “Representation” described therein. The “Representation” has the URL “stream5.mp4” of the image file of the high-resolution encoded stream of the end image 173 described therein. Since a level is set for the encoded stream of the end image 173, “SubRepresentation” per level can be described in the “Representation.”

Therefore, the “SubRepresentation” of level “1” has <SupplementalProperty schemeldUri=“urn:mpeg:dash:srd:2014” value=“1,2880,540,960,1080,3840,2160,2”/> which represents the SRD of the left end image 173-1 described therein. The SRD of the left end image 173-1 is thus set in association with the position on the end image 173 of the left end image 173-1 indicated by the Tile Region Group Entry corresponding to level “1”

The “SubRepresentation” of level “2” has <SupplementalProperty schemeldUri=“urn:mpeg:dash:srd:2014” value=“1,0,540,960,1080,3840,2160,2”/> which represents the SRD of the right end image 173-2 described therein. The SRD of the right end image 173-2 is thus set in association with the position on the end image 173 of the right end image 173-2 indicated by the Tile Region Group Entry corresponding to level “2.”

According to the second embodiment, as described above, different levels are set for the left end image 173-1 and the right end image 173-2. Therefore, positions on the screen 180 of the left end image 173-1 and the right end image 173-2 that make up the end image 173 corresponding to the encoded stream can be described by the SRD.

The streaming player 190 places the left end image 173-1 in the position indicated by the Tile Region Group Entry corresponding to level “1,” of the decoded end image 173, on the screen 180 on the basis of the SRD of level “1” set in the MPD file. The streaming player 190 also places the right end image 173-2 in the position indicated by the Tile Region Group Entry corresponding to level “2,” of the decoded end image 173, on the screen 180 on the basis of the SRD of level “2” set in the MPD file.

According to the second embodiment, the encoded stream of the end image 173 is placed on one track. However, if the left end image 173-1 and the right end image 173-2 are encoded as different tiles according to the HEVC process, then their respective slice data may be placed on different tracks.

### (Example of a Track Structure)

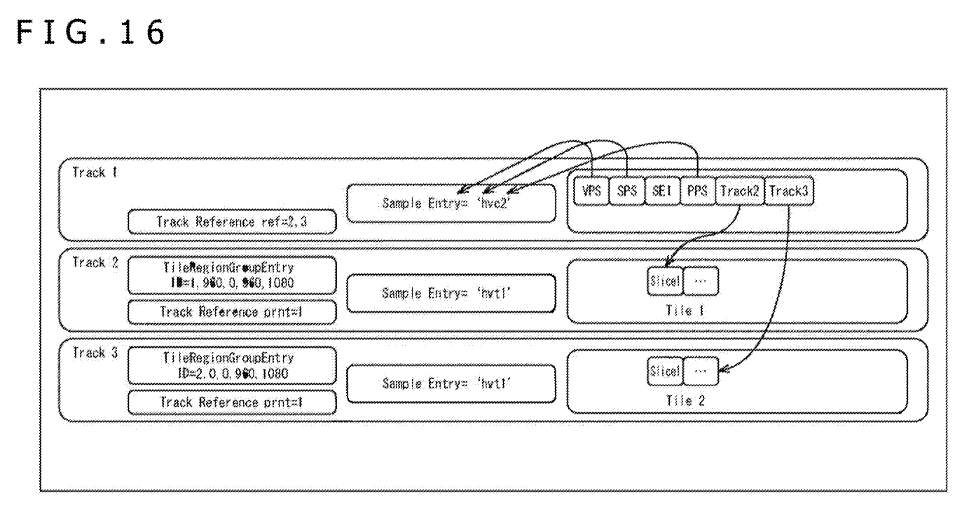

FIG. 16 is a diagram depicting an example of a track structure where the slice data of the left end image 173-1 and the right end image 173-2 are placed on different tracks.

If the slice data of the left end image 173-1 and the right end image 173-2 are placed on different tracks, then three tracks are placed in the image file of the end image 173, as depicted in FIG. 16.

The track box of each track has Track Reference placed therein. The Track Reference represents reference relationship of a corresponding track to another track. Specifically, the Track Reference represents an ID (hereinafter referred to as “track ID”) inherent in another track to which the corresponding track has reference relationship. A sample of each track is managed by Sample Entry.

The track whose track ID is 1 is a base track that does not include the slice data of the encoded stream of the end image 173. Specifically, a sample of the base track has parameter sets placed therein which include VPS (Video Parameter Set), SPS (Sequence Parameter Set), SEI (Supplemental Enhancement Information), PPS (Picture Parameter Set), etc., of the encoded stream of the end image 173. The sample of the base track also has extractors in the unit of samples of the other tracks than the base track, placed therein as subsamples. An extractor includes the type of the extractor and information indicating the position of the sample of the corresponding track in the file and the size thereof.

The track whose track ID is 2 is a track that includes slice data of the left end image 173-1 of the encoded stream of the end image 173, as a sample. The track whose track ID is 3 is a track that includes slice data of the right end image 173-2 of the encoded stream of the end image 173, as a sample.

### (Example of an Leva Box)

The segment structure of the image file of the end image 173 in the case where the slice data of the left end image 173-1 and the right end image 173-2 are placed on different tracks is the same as the segment structure depicted in FIG. 13 except for the leva box. Therefore, only the leva box will be described below.

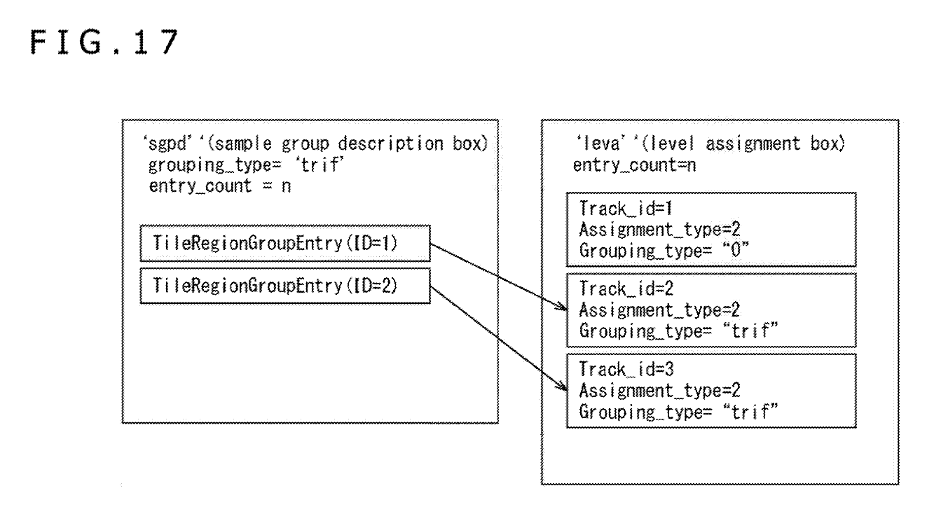

FIG. 17 is a diagram depicting an example of the leva box of the image file of the end image 173 in the case where the slice data of the left end image 173-1 and the right end image 173-2 are placed on different tracks.

As depicted in FIG. 17, the leva box of the image file of the end image 173 in the case where the slice data of the left end image 173-1 and the right end image 173-2 are placed on different tracks has levels “1” through “3” successively set for the tracks having track IDs “1” through “3.”

The leva box depicted in FIG. 17 has track IDs described therein for the tracks including slice data of the region in the end image 173 for which levels are set, as information of the respective levels. In the example depicted in FIG. 17, the track IDs “1,” “2,” and “3” are described respectively as information of levels “1,” “2,” and “3.”

In FIG. 17, the slice data of the encoded stream of the end image 173 as an object for which levels are to be set is placed on a plurality of tracks. Therefore, the assignment_type included in the level information of each level is 2 or 3 indicating that the object for which levels are to be set is an encoded stream placed on a plurality of tracks.

In FIG. 17, furthermore, there is no Tile Region Group Entry corresponding to level “1.” Therefore, the type of Tile Region Group Entry included in the information of level “1” is grouping type “0” indicating that there is no Tile Region Group Entry. By contrast, Tile Region Group Entry corresponding to levels “2” and “3” is Tile Region Group Entry included in the sgpd box. Therefore, the type of Tile Region Group Entry included in the information of levels “2” and “3” is “trif” which is the type of Tile Region Group Entry included in the sgpd box.

### (Another Example of an MPD File)

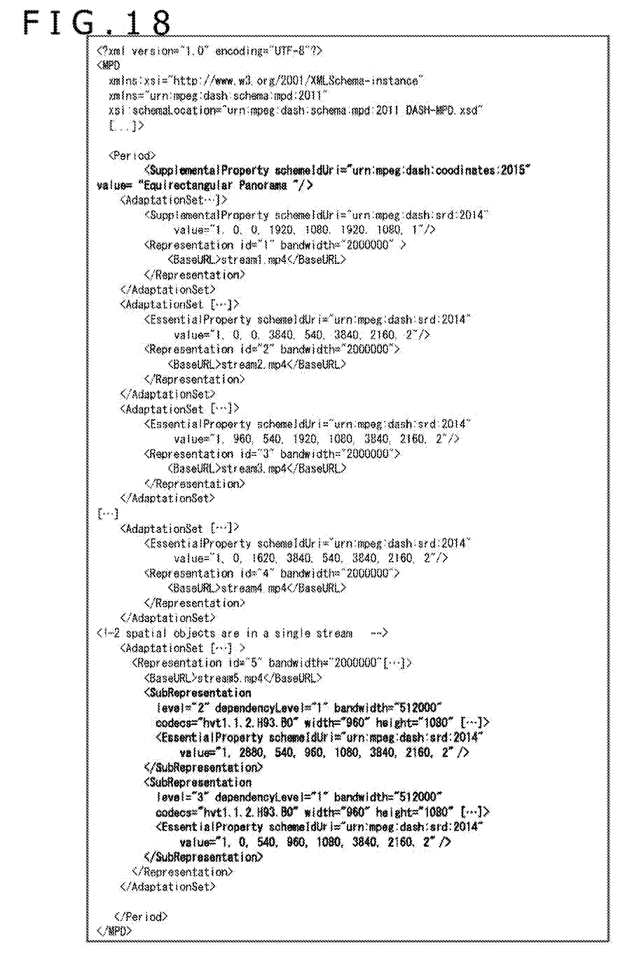

FIG. 18 is a diagram depicting an example of an MPD file where the slice data of the left end image 173-1 and the right end image 173-2 are placed on different tracks.

The MPD file depicted in FIG. 18 is the same as the MPD file depicted in FIG. 15 except for the elements of each “SubRepresentation” of the fifth “AdaptationSet.”

Specifically, in the MPD file depicted in FIG. 18, the first “SubRepresentation” of the fifth “AdaptationSet” is “SubRepresentation” of level “2.” Therefore, level “2” is described as an element of “SubRepresentation.”

The track of the track ID “2” corresponding to level “2” has a dependent relationship to the base track of the track ID “1.” Consequently, dependencyLevel representing the level corresponding to the track in the dependent relationship, which is described as an element of “SubRepresentation,” is set to “1.”

The track of the track ID “2” corresponding to level “2” is HEVC Tile Track. Therefore, codecs representing the type of encoding described as an element of “SubRepresentation” is set to “hvt1.1.2.H93.B0” that indicates HEVC Tile Track.

In the MPD file depicted in FIG. 18, the second “SubRepresentation” of the fifth “AdaptationSet” is “SubRepresentation” of level “3.” Therefore, level “3” is described as an element of “SubRepresentation.”

The track of the track ID “3” corresponding to level “3” has a dependent relationship to the base track of the track ID “1.” Consequently, dependencyLevel described as an element of “SubRepresentation” is set to “1.”

The track of the track ID “3” corresponding to level “3” is HEVC Tile Track. Therefore, codecs described as an element of “SubRepresentation” is set to “hvt1.1.2.H93.B0.”

As described above, if the left end image 173-1 and the right end image 173-2 are encoded as different tiles, then the decoder 194-2 or the decoder 194-3 depicted in FIG. 11 can decode the left end image 173-1 and the right end image 173-2 independently of each other. If the slice data of the left end image 173-1 and the right end image 173-2 are placed on different tracks, then either one of the slice data of the left end image 173-1 and the right end image 173-2 can be acquired. Therefore, the MPD processor 192 can select only one of the left end image 173-1 and the right end image 173-2 as a selected image.

In the above description, the slice data of the left end image 173-1 and the right end image 173-2 that are encoded as different tiles are placed on different tracks. However, they may be placed on one track.

In the first and second embodiments, the image of the moving-image content represents an entire celestial sphere image. However, it may be a panoramic image.

### Third Embodiment

### (Example of an Entire Celestial Sphere Image in a Third Embodiment of the Information Processing System)

The third embodiment of the information processing system to which the present disclosure is applied is of the same configuration as the information processing system 10 depicted in FIG. 1 except that the mapping process for the entire celestial sphere image is the cube mapping process, the number of divisions of the entire celestial sphere image is 6, and region information indicating the regions of filler images is set in an MPD file. Redundant descriptions will be omitted as required.

FIG. 19 is a diagram depicting an example of an image to be encoded in the third embodiment of the information processing system to which the present disclosure is applied.

As depicted in FIG. 19, providing the mapping process for the entire celestial sphere image is the cube mapping process, an image 210 to be encoded is a rectangular image where filler images 212-1 through 212-4 are added to an entire celestial sphere image 211 of a cube produced after an omnidirectional image has been mapped onto a cubic plane. According to the third embodiment, specifically, after the entire celestial sphere image 211 is generated, the mapping processor adds the filler images 212-1 through 212-4 to the entire celestial sphere image 211, generating a rectangular image 210, which is supplied to a resolution downscaler and a divider. As a result, encoded streams of the image 210 are generated as encoded streams of the entire celestial sphere image 211. In the example depicted in FIG. 19, the image 210 is made up of 2880 pixels×2160 pixels. The filler images are filling images devoid of actual data.

In the entire celestial sphere image 211, the images of the six faces of the cube are depicted as images 221 through 226. Therefore, the image 210 is divided into an upper image 231 made up of filler images 212-1 and 212-3 and an image 223, an image 222, an image 225, an image 221, an image 226, and a lower image 232 made up of filler images 212-2 and 212-4 and an image 224. The upper image 231, the image 222, the image 225, the image 221, the image 226, and the lower image 232 that are divided are encoded independently of each other, generating six high-resolution encoded streams.

Generally, the image 210 is generated such that the front of the image 210 at a position on the image 210 that is located at the center of the field of view in the standard direction of line-of-sight lies at the center O of the image 225.

### (Example of Continuity Information)

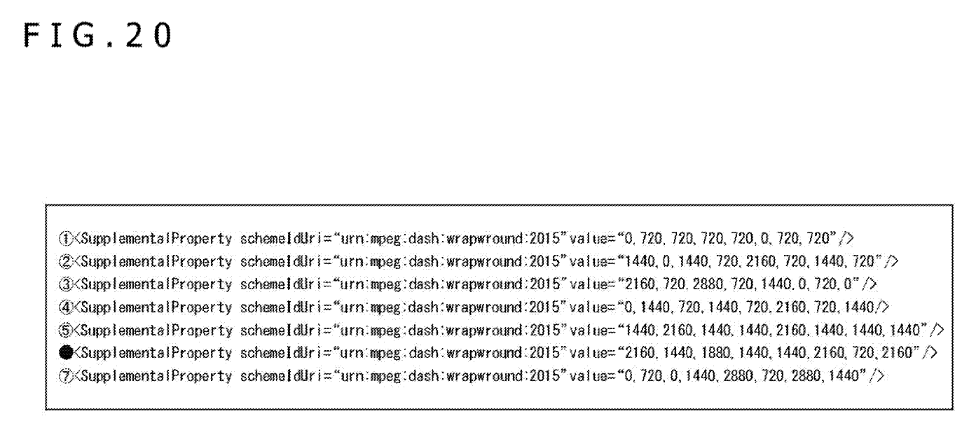

FIG. 20 is a diagram depicting an example of continuity information described in an MPD file.

If continuity information is information indicating sides as contiguous ends of an entire celestial sphere image, then seven items of continuity information are described, as depicted in FIG. 20.

Specifically, <SupplementalProperty schemeldUri=“urn:mpeg:dash:wrapwround:2015” value=“0,720,720,720,720,0,720,720”/> indicating an upper side 222A (FIG. 19) of the image 222 and a left side 223A of the image 223 which are contiguous to each other is written as the first item of continuity information.

<SupplementalProperty schemeldUri=“urn:mpeg:dash:wrapwround:2015” value=“1440,0,1440,720,2160,720,1440,720”/> indicating a right side 223B of the image 223 and an upper side 221B of the image 221 which are contiguous to each other is written as the second item of continuity information.

<SupplementalProperty schemeldUri=“urn:mpeg:dash:wrapwround:2015” value=“2160,720,2880,720,1440,0,720,0”/> indicating a upper side 226C of the image 226 and an upper side 223C of the image 223 which are contiguous to each other is written as the third item of continuity information.

<SupplementalProperty schemeldUri=“urn:mpeg:dash:wrapwround:2015” value=“0,1440,720,1440,720,2160,720,1440”/> indicating a lower side 222B of the image 222 and a left side 224B of the image 224 which are contiguous to each other is written as the fourth item of continuity information.

<SupplementalProperty schemeldUri=“urn:mpeg:dash:wrapwround:2015” value=“1440,2160,1440,1440,2160,1440,1440,1440”/> indicating a right side 224A of the image 224 and a lower side 221A of the image 221 which are contiguous to each other is written as the fifth item of continuity information.

<SupplementalProperty schemeldUri=“urn:mpeg:dash:wrapwround:2015” value=“2160,1440,1880,1440,1440,2160,720,2160”/> indicating a lower side 226D of the image 226 and a lower side 224D of the image 224 which are contiguous to each other is written as the sixth item of continuity information.

<SupplementalProperty schemeldUri=“urn:mpeg:dash:wrapwround:2015” value=“0,720,0,1440,2880,720,2880,1440”/> indicating a left side 222E of the image 222 and a right side 226E of the image 226 which are contiguous to each other is written as the seventh item of continuity information.

According to the third embodiment, the continuity information may be information indicating the mapping process for the entire celestial sphere image. In this case, <SupplementalProperty schemeldUri=“urn:mpeg:dash:coodinates:2015” value=“cube texture map”/> which indicates that the mapping process is the cube mapping process is described as the continuity information in the MPD file.

### (Example of Region Information)

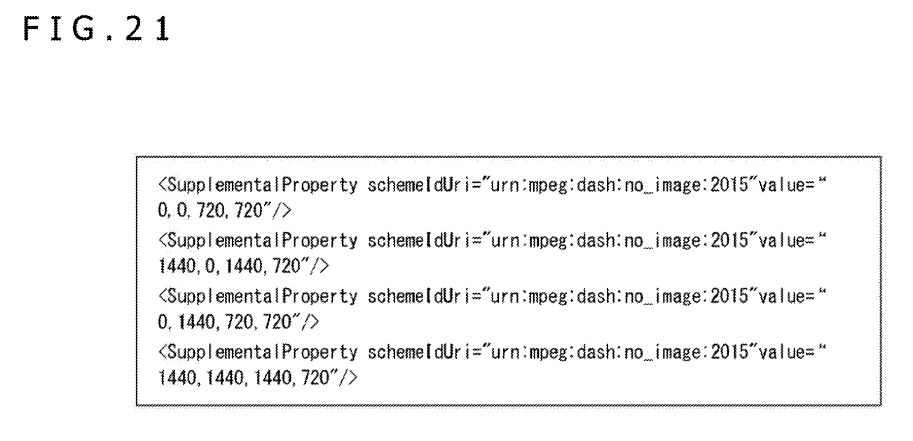

FIG. 21 is a diagram depicting an example of region information of the filler images 212-1 through 212-4 depicted in FIG. 19.

As depicted in FIG. 21, the region information is represented as <SupplementalProperty schemeIdUri=“urn:mpeg:dash:no_image:2015” value=“x,y,width,height”/> indicating the coordinates (X,Y) of the upper left corner of the region of a filler image, the horizontal size thereof as “width,” and the vertical size thereof as “height.”

Consequently, the region information of the filler image 212-1 is represented as <SupplementalProperty schemeIdUri=“urn:mpeg:dash:no_image:2015” value=“0,0,720,720”/>, and the region information of the filler image 212-2 is represented as <SupplementalProperty schemeIdUri=“urn:mpeg:dash:no_image:2015” value=“0,1440,720,720”/>.

The region information of the filler image 212-3 is represented as <SupplementalProperty schemeIdUri=“urn:mpeg:dash:no_image:2015” value=“1440,0,1440,720”/>, and the region information of the filler image 212-4 is represented as <SupplementalProperty schemeIdUri=“urn:mpeg:dash:no_image:2015” value=“1440,1440,1440,720”/>.

According to the third embodiment, as described above, region information is described in the MPD file. Therefore, in the event that a decoding process results in no actual data, the streaming player can recognize whether the result of the decoding process is caused by a filler image or a decoding error.

### Fourth Embodiment

(Description of a Computer to which the Present Disclosure is Applied)

The above sequence of processes may be hardware-implemented or software-implemented. If the sequence of processes is software-implemented, then software programs are installed in a computer. The computer may be a computer incorporated in dedicated hardware or a general-purpose personal computer which is capable of performing various functions by installing various programs.

FIG. 22 is a block diagram depicting a configurational example of the hardware of a computer that executes the above sequence of processes based on programs.

A computer 900 includes a CPU (Central Processing Unit) 901, a ROM (Read Only Memory) 902, and a RAM (Random Access Memory) 903 that are connected to each other by a bus 904.

An input/output interface 905 is connected to the bus 904. To the input/output interface 905, there are connected an input unit 906, an output unit 907, a storage unit 908, a communication unit 909, and a drive 910.

The input unit 906 includes a keyboard, a mouse, and a microphone, etc. The output unit 907 includes a display and a speaker, etc. The storage unit 908 includes a hard disk and a non-volatile memory, etc. The communication unit 909 includes a network interface, etc. The drive 910 works on a removable medium 911 such as a magnetic disk, an optical disk, a magneto-optical disk, a semiconductor memory, or the like.

In the computer 900 thus constructed, the CPU 901 loads programs stored in the storage unit 908, for example, through the input/output interface 905 and the bus 904 into the RAM 903 and executes the programs to perform the processes described above.

The programs run by the computer 900 (the CPU 901) can be recorded on and provided by the removable medium 911 as a package medium or the like, for example. The programs can also be provided through a wired or wireless transmission medium such as a local area network, the Internet, or a digital satellite broadcast.

In the computer 900, the programs can be installed in the storage unit 908 through the input/output interface 905 when the removable medium 911 is inserted into the drive 910. The programs can also be received by the communication unit 909 through a wired or wireless transmission medium and installed in the storage unit 908. The programs can alternatively be pre-installed in the ROM 902 or the storage unit 908.

The programs that are executed by the computer 900 may be programs in which processes are carried out in chronological order in the sequence described above, or may be programs in which processes are carried out parallel to each other or at necessary timings as when called for.

In the present specification, the term “system” means a collection of components (apparatus, modules (parts), or the like), and it does not matter whether all the components are present in the same housing or not. Therefore, both a plurality of apparatus housed in each housing and connected by a network, and a single apparatus having a plurality of modules housed in one housing may be referred to as a system.

The advantages referred to above in the present specification are only illustrative, but not limitative, do not preclude other advantages.

The embodiments of the present disclosure are not limited to the above embodiments, and various changes may be made therein without departing from the scope of the present disclosure.

The present disclosure may be presented in the following configurations:

(1)

An information processing apparatus including:

a setting section that sets continuity information representing continuity of ends of an image compatible with encoded streams.
(2)

The information processing apparatus according to (1), in which the continuity information is information representing a mapping process for the image.

(3)

The information processing apparatus according to (1), in which the continuity information is information representing whether the continuity of the ends in horizontal and vertical directions of the image is present or absent.

(4)

The information processing apparatus according to (1), in which the continuity information is information representing the ends that are contiguous to each other.

(5)

The information processing apparatus according to (1), (2) or (4), further including:

a generator that adds a filler image to the image which is mapped by a cube mapping process, thereby generating a rectangular image; and
an encoder for encoding the image generated by the generator, thereby generating the encoded streams,
in which the setting section sets region information representing a region of the filler image in the image.
(6)

The information processing apparatus according to any one of (1) through (5), in which the setting section sets the continuity information in a management file that manages files of the encoded streams.

(7)

An information processing method including:

a setting step that sets continuity information representing continuity of ends of an image compatible with encoded streams in an information processing apparatus.
(8)

An information processing apparatus including:

an acquirer that acquires encoded streams on the basis of continuity information representing continuity of ends of an image compatible with the encoded streams; and
a decoder that decodes the encoded streams acquired by the acquirer.
(9)

The information processing apparatus according to (8), in which the continuity information is information representing a mapping process for the image.

(10)

The information processing apparatus according to (8), in which the continuity information is information representing whether the continuity of the ends in horizontal and vertical directions of the image is present or absent.

(11)

The information processing apparatus according to (8), in which the continuity information is information representing the ends that are contiguous to each other.

(12)

The information processing apparatus according to (8), (9) or (11), in which the encoded streams are encoded streams of a rectangular image that is generated by adding a filler image to the image which is mapped by a cube mapping process, and the decoder decodes the encoded streams on the basis of region information representing a region of the filler image in the image.

(13)

The information processing apparatus according to any one of (8) through (12), in which the continuity information is set in a management file that manages files of the encoded streams.

(14)

An information processing method including:

an acquiring step that acquires encoded streams on the basis of continuity information representing continuity of ends of an image compatible with the encoded streams; and
a decoding step that decodes the encoded streams acquired by the process in the acquiring step, in an information processing apparatus.

### REFERENCE SIGNS LIST

11 File generating apparatus, 14 Moving-image playback terminal, 152 Mapping processor, 156-1 through 156-4 Encoder, 170 Entire celestial sphere image, 193 Image file acquirer, 194-1 through 194-3 Decoder, 210 Image, 211 Entire celestial sphere image, 212-1 through 212-4 Filler image

1. An information processing apparatus comprising:
a setting section that sets continuity information representing continuity of ends of an image compatible with encoded streams.

2. The information processing apparatus according to claim 1, wherein the continuity information is information representing a mapping process for the image.

3. The information processing apparatus according to claim 1, wherein the continuity information is information representing whether the continuity of the ends in horizontal and vertical directions of the image is present or absent.

4. The information processing apparatus according to claim 1, wherein the continuity information is information representing the ends that are contiguous to each other.

5. The information processing apparatus according to claim 1, further comprising:
a generator that adds a filler image to the image which is mapped by a cube mapping process, thereby generating a rectangular image; and
an encoder for encoding the image generated by the generator, thereby generating the encoded streams,
wherein the setting section sets region information representing a region of the filler image in the image.

6. The information processing apparatus according to claim 1, wherein the setting section sets the continuity information in a management file that manages files of the encoded streams.

7. An information processing method comprising:
a setting step that sets continuity information representing continuity of ends of an image compatible with encoded streams in an information processing apparatus.

8. An information processing apparatus comprising:
an acquirer that acquires encoded streams on the basis of continuity information representing continuity of ends of an image compatible with the encoded streams; and
a decoder that decodes the encoded streams acquired by the acquirer.

9. The information processing apparatus according to claim 8, wherein the continuity information is information representing a mapping process for the image.

10. The information processing apparatus according to claim 8, wherein the continuity information is information representing whether the continuity of the ends in horizontal and vertical directions of the image is present or absent.

11. The information processing apparatus according to claim 8, wherein the continuity information is information representing the ends that are contiguous to each other.

12. The information processing apparatus according to claim 8, wherein the encoded streams are encoded streams of a rectangular image that is generated by adding a filler image to the image which is mapped by a cube mapping process, and
the decoder decodes the encoded streams on the basis of region information representing a region of the filler image in the image.

13. The information processing apparatus according to claim 8, wherein the continuity information is set in a management file that manages files of the encoded streams.

14. An information processing method comprising:
an acquiring step that acquires encoded streams on the basis of continuity information representing continuity of ends of an image compatible with the encoded streams; and
a decoding step that decodes the encoded streams acquired by the process in the acquiring step, in an information processing apparatus.
